(19) United States
(12) Patent Application Publication
(10) Pub. No.: US 2023/0192121 A1
(43) Pub. Date: Jun. 22, 2023

(54) CLASS-AWARE DEPTH DATA CLUSTERING

(71) Applicant: GM Cruise Holdings LLC, San Francisco, CA (US)

(72) Inventors: Weizhe Zhang, Fremont, CA (US); Shaogang Wang, Pittsburgh, PA (US); Anton Mario Bongio Karrman, Los Angeles, CA (US); Kotung Lin, San Carlos, CA (US)

(21) Appl. No.: 17/560,002

(22) Filed: Dec. 22, 2021

(51) Int. Cl. G06K 9/00; G08G 1/16; G01C 21/00; B60W 60/00

(52) U.S. Cl. CPC G06K 9/00503; B60W 60/001; G01C 21/3807; G06K 9/00536; G08G 1/166; B60W 2420/52; B60W 2554/801; B60W 2554/802; B60W 2554/4029

(57) ABSTRACT

Depth data processing systems and methods are disclosed. A mapping system receives, from one or more depth sensors, depth sensor data that includes a plurality of points corresponding to an environment. The mapping system uses one or more trained machine learning models to perform semantic segmentation of the plurality of points, to classify a first subset of the points into a first category and to classify a second subset of the points into a second category. The mapping system clusters the plurality of points into a plurality of clusters based on the semantic segmentation. At least some of the first subset of the points are clustered into a first cluster and at least some of the second subset of the points are clustered into a second cluster. The mapping system generates a map of at least a portion of the environment based on the plurality of clusters.

### TECHNICAL FIELD

The present technology generally pertains to clustering of points in depth information from a depth sensor. More specifically, the present technology pertains to class-aware clustering of points based on semantic segmentation of the points, for instance to classify the points by object type or class.

### BACKGROUND

Autonomous vehicles (AVs) are vehicles having computers and control systems that perform driving and navigation tasks that are conventionally performed by a human driver. As AV technologies continue to advance, a real-world simulation for AV testing has been critical in improving the safety and efficiency of AV driving.

As an AV drives through an environment, the AV may encounter other objects in the environment, such as pedestrians, bicyclists, trees, and other vehicles. These objects may present a collision risk for the AV.

### BRIEF DESCRIPTION OF THE DRAWINGS

The advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example of a system for managing one or more autonomous vehicles (AVs) in accordance with some aspects of the present technology;

FIG. 2 is a conceptual diagram illustrating exemplary clustering of points of depth data into four clusters, in accordance with some aspects of the present technology;

FIG. 3 is a block diagram illustrating an architecture of a depth data processing system, in accordance with some aspects of the present technology;

FIG. 4 is a conceptual diagram illustrating hierarchy of object categories for the semantic segmentation engine, in accordance with some aspects of the present technology;

FIG. 5 is a conceptual diagram illustrating map data for of an environment based on clustered depth data that is clustered based on semantic segmentation, in accordance with some aspects of the present technology;

FIG. 6 is a block diagram illustrating an example of a neural network that can be used for environment analysis, in accordance with some examples;

FIG. 7 is a flow diagram illustrating a process for environmental analysis in accordance with some examples; and

FIG. 8 shows an example of a system for implementing certain aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology. In some instances, well-known structures and devices are shown in block diagram form in order to facilitate describing one or more aspects. Further, it is to be understood that functionality that is described as being carried out by certain system components may be performed by more or fewer components than shown.

Autonomous vehicles (AVs) are vehicles having computers and control systems that perform driving and navigation tasks that are conventionally performed by a human driver. As AV technologies continue to advance, a real-world simulation for AV testing has been critical in improving the safety and efficiency of AV driving.

An Autonomous Vehicle (AV) is a motorized vehicle that can navigate without a human driver. An exemplary autonomous vehicle includes a plurality of sensor systems, such as, but not limited to, a camera sensor system, a Light Detection and Ranging (LIDAR) sensor system, a Radio Detection and Ranging (RADAR) sensor system, a Sound Detection and Ranging (SODAR) amongst others. The autonomous vehicle operates based upon sensor signals output by the sensor systems. Specifically, the sensor signals are provided to an internal computing system in communication with the plurality of sensor systems, wherein a processor executes instructions based upon the sensor signals to control a mechanical system of the autonomous vehicle, such as a vehicle propulsion system, a braking system, or a steering system. Similar sensors may also be mounted onto non-autonomous vehicles, for example onto vehicles whose sensor data is used to generate or update street maps.

As an AV drives through an environment, the AV may encounter other objects in the environment, such as pedestrians, bicyclists, trees, and other vehicles. These objects may present a collision risk for the AV, especially if the AV is unable to properly detect the objects. For instance, these objects may present a collision risk for the AV if the AV mistakenly identifies two different types of object that happen to be near one another (e.g., a car and a pedestrian near the car) as a single object (e.g., just the car), since the car may be unaware of the existence of the other object (e.g., the pedestrian) as a result.

Depth data processing systems and methods are disclosed. In some examples, a mapping system receives, from one or more depth sensors, depth sensor data that includes a plurality of points corresponding to an environment. The one or more depth sensors may include, for example, RADAR sensors, LIDAR sensors, pseudo-LIDAR sensors, SONAR sensors, SODAR sensors, ultrasonic sensors, ToF sensors, structured light sensors, or combinations thereof. The mapping system uses one or more trained machine learning models to perform semantic segmentation of the plurality of points. The semantic segmentation classifies a first subset of the plurality of points into a first category and classifies a second subset of the plurality of points into a second category. In an illustrative example, the first category is a car category, while the second category is a pedestrian category. The mapping system clusters the plurality of points into a plurality of clusters based on the semantic segmentation. At least some of the first subset of the plurality of points are clustered into a first cluster and at least some of the second subset of the plurality of points are clustered into a second cluster. The mapping system generates a map of at least a portion of the environment based on the plurality of clusters. In some aspects, the housing is a vehicle housing of a vehicle, the mapping system generates a route through the environment based on the map that the vehicle autonomously drives along.

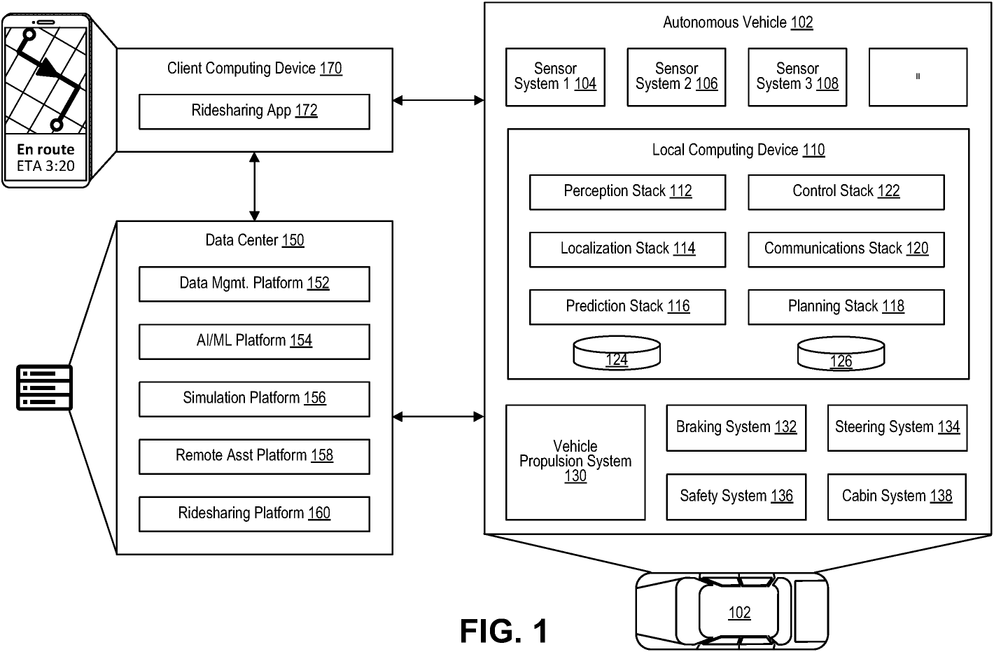

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., cameras, image sensors, LIDAR systems, pseudo-LIDAR systems, ambient light sensors, infrared sensors, etc.), RADAR systems, positioning receivers (e.g., Global Positioning System (GPS) receivers, Global Navigation Satellited System (GNSS) receivers, etc.), audio sensors (e.g., microphones, Sound Detection and Ranging (SODAR) systems, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV’s environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV’s position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV’s steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user’s mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112 - 122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pickup and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer’s mobile computing device or a computing device integrated with the AV 102 (e.g., the local computing device 110). The ridesharing platform 160 can receive requests to pick up or drop off from the ridesharing application 172 and dispatch the AV 102 for the trip.

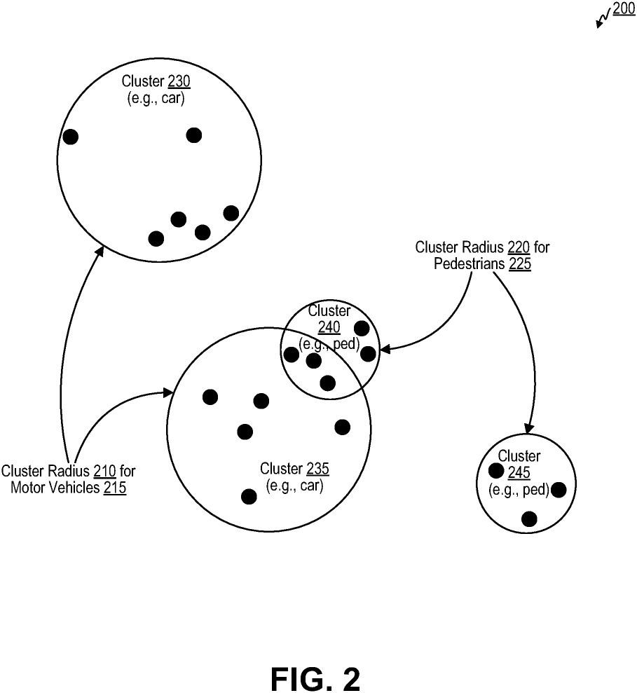

FIG. 2 is a conceptual diagram illustrating exemplary clustering of points of depth data into four clusters. The points are illustrated as small black circles, and are examples of points from depth data captured by one or more depth sensors of an AV 102. The depth sensor(s) of the AV 102 that capture the points may include, for example, one or more RADAR sensors, LIDAR sensors, pseudo-LIDAR sensors, SONAR sensors, SODAR sensors, ultrasonic sensors, ToF sensors, structured light sensors, or combinations thereof.

The points in FIG. 2 are illustrated clustered into four clusters, including a cluster 230 representing a car, a cluster 235 representing another car, a cluster 240 representing a pedestrian, and cluster 245 representing another pedestrian. The AV 102 clusters the points together using one or more clustering algorithms. Different clustering algorithms can rely on different distance measures. The clustering algorithm(s) used by the AV 102 to cluster the points can include density-based spatial clustering of applications with noise (DBSCAN) (e.g., clustering based on distance between nearest points), K-Means clustering (e.g., clustering based on distance between points), affinity propagation (e.g., clustering based on graph distance), mean-shift clustering (e.g., clustering based on distance between points), gaussian mixture clustering (e.g., clustering based on Mahalanobis distance to centers), spectral clustering (e.g., clustering based on graph distance), hierarchical agglomerative clustering (HAC) (e.g., clustering based on a hierarchy of clusters going from the bottom up and merging pairs of clusters as one moves up the hierarchy), hierarchical divisive clustering (HDC) (e.g., clustering based on a hierarchy of clusters going from the top down and splitting up clusters as one moves down the hierarchy), correlation clustering (e.g., clustering based on similarity and/or relationships between points), or a combination thereof.

In some examples, the clustering algorithm(s) cluster a set of points together into a cluster based on the points in the set being within a threshold distance of each other, of a centroid, of the nearest points of the set, another distance measure indicated in the list of clustering algorithms above, or a combination thereof. The distance measure may be measured as a Euclidean distance, a Manhattan distance, a Mahalanobis distance, a Minkowski distance, a Hamming distance, a graph distance, cosine distance, a Jaccard distance, or a combination thereof.

Of the four clusters illustrated in FIG. 2, the points of the cluster 230 and the points of the cluster 245 are far from any other points. Thus, the clustering algorithm(s) of the AV 102 can cluster the points of the cluster 230 into the cluster 230, and can cluster the points of the cluster 245 into the cluster 245, with high certainty and little room for error. However, the cluster 235 and the cluster 240 overlap, with some points being in the intersection of the cluster 235 and the cluster 240. Depending on the clustering algorithm(s) used by the AV 102, for instance, the AV 102 may in some cases erroneously miscategorize the points of the cluster 235 and the points of the cluster 240 as belonging to a single cluster corresponding to a single object. In an illustrative example, the AV 102 may erroneously miscategorize the points of the cluster 235 and the points of the cluster 240 as both belonging to a variant of the cluster 235 (e.g., perhaps with the center moved slightly toward the points of the cluster 240). This type of error can be very dangerous for an AV 102 to make, as it can result in the AV 102 failing to detect the pedestrian represented by the cluster 240, and can potentially result in a collision between the AV 102 and the pedestrian.

In some examples, a described further herein, the AV 102 may perform semantic segmentation to classify a first subset of the points as belonging to a first type of object, classify a second subset of the points as belonging to a second type of object, and so forth. The AV 102 can provide the results of the semantic segmentation to the clustering algorithm(s) and can configure the clustering algorithm(s) to ensure that points classified as belonging to different types of objects do not get clustered together. For instance, the AV 102 can configure the clustering algorithm(s) to ensure that points classified as belonging to motor vehicles, and points belonging to pedestrians, do not get clustered together. This can help to ensure that the clustering algorithm(s) properly cluster the points of the cluster 230 into the cluster 230, and the points of the cluster 245 into the cluster 245, rather than mistakenly clustering the points of clusters 230 and 245 into a single cluster. In some examples, the AV 102 can configure the clustering algorithm(s) to provide different threshold distances, or cluster radiuses, for clustering points belonging different types of objects. For example, in FIG. 2, a cluster radius 210 for motor vehicles 215 (as a type of object) is illustrated as the respective circles around clusters 230 and 235 (which represent cars), and is larger than a cluster radius 220 for pedestrians 225 (as a type of object), which is illustrated as the respective circles around clusters 240 and 245 (which represent pedestrians). Because pedestrians 225 are smaller than motor vehicles 215, the smaller cluster radius 220 for pedestrians 225 can ensure that the clustering algorithm(s) of the AV 102 search for small clusters representing pedestrians, not just larger clusters such as those representing motor vehicles 215. Cluster radiuses may also be referred to as threshold radiuses, threshold distances, search radiuses, search distances, or combinations thereof.

Type of object may be referred to as object type, class, classification, semantic class, category, semantic category, object class, object category, object class, object classification, or a combination thereof

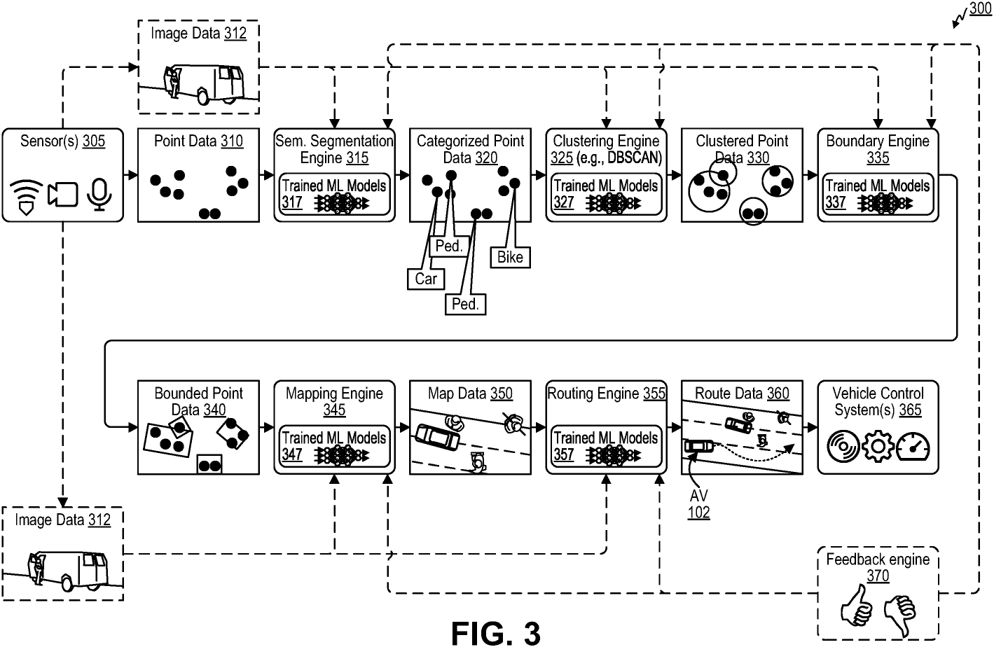

FIG. 3 is a block diagram illustrating an architecture of a depth data processing system 300. The depth data processing system 300 includes one or more sensors 305 of the AV 102. The sensor(s) 305 can include, for instance, the sensor system 1 104, the sensor system 2 106, the sensor system 3 108, the depth sensor 525, the image sensor 560, one or more sensors providing sensor data to the input layer 610 of the neural network (NN) 600, the depth sensor of operation 705, an input device 845, any other sensors or sensors systems described herein, or a combination thereof. In an illustrative example, the sensor(s) 305 include depth sensor(s), such as LIDAR sensor(s), pseudo-LIDAR sensor(s), RADAR sensor(s), SONAR sensor(s), SODAR sensor(s), ultrasonic sensor(s), laser rangefinder(s), ToF sensor(s), structured light sensor(s), or combinations thereof. Depth sensors may be referred to as range sensors or distance sensors. In some examples, the sensor(s) 305 include image sensor(s) of camera(s). In some examples, the sensor(s) 305 include one or more microphone(s). In some examples, the sensor(s) 305 include one or more pose sensor(s), such as inertial measurement unit(s), gyroscope(s), gyrometer(s), accelerometer(s), altimeter(s), barometer(s), or combinations thereof. In some examples, the sensor(s) 305 include one or more positioning receiver(s), such as GNSS receiver(s), GPS receiver(s), accelerometer(s), altimeter(s), barometer(s), Wi-Fi transceivers, cellular network transceivers, wireless local area network (WLAN) transceivers, Bluetooth transceivers, beacon transceivers, personal area network (PAN) transceivers, municipal area network (MAN) transceivers, wide area network (WAN) transceivers, communication interface(s) 840, or combinations thereof. In some examples, the sensor(s) 305 include one or more vehicle status sensors, such as engine sensor(s), speedometer(s), tachometer(s), odometer(s), altimeter(s), tilt sensor(s), impact sensor(s), airbag sensor(s), seat occupancy sensor(s), open/closed door sensor(s), on/off light sensor(s), tire pressure sensor(s), rain sensor(s), or combinations thereof. The sensor(s) 305 are illustrated in FIG. 3 as including a depth sensor, a camera, and a microphone.

The sensor(s) 305 capture sensor data. The sensor data can include one or more representations of at least portion(s) of an environment around the AV 102. The sensor data can include, for example, image data (e.g., one or more images and/or videos) captured by image sensor(s) of camera(s) of the AV 102. The image data may include depictions of at least portions of the environment around the AV 102. The sensor data can include, for example, depth data (e.g., one or more point clouds, depth images, depth videos, range images, range videos, 3D models, and/or distance measurements) captured by depth sensor(s) of the AV 102. The depth data may be referred to as range data or distance data. The depth data may include depth-based representations of at last portions of the environment around the AV 102. The sensor data can include audio recorded from the environment around the AV 102 using microphone(s). In some examples, the audio may include directional information (e.g., what direction a sound is coming from) based on differences in amplitude and/or frequency recorded at different microphones at different positions on or along the AV 102, which can be considered an audio representation of at least a portion of the environment around the AV 102. In some examples, the sensor data can include pose data identifying a pose of the AV 102. A pose of the AV 102 can include a location of the AV 102 (e.g., latitude, longitude, attitude, elevation, and/or other coordinate data in 3D space), an orientation of the AV 102 (e.g., pitch, yaw, and/or roll), a velocity of the AV 102 (e.g., speed, direction), an acceleration of the AV 102 (e.g., acceleration rate, acceleration direction), or a combination thereof. In some examples, the sensor data can include vehicle status information from the vehicle status sensor(s), such as engine status, speed, airbag status, and the like.

The sensor(s) 305 of FIG. 3 include depth sensor(s) that capture depth data, including the point data 310. The point data 310 is illustrated in FIG. 3 as including eight points representing portions of the environment around the AV 102. It should be understood that this number of points is exemplary, and that the point data 310 may include more than eight points or fewer than eight points. In some examples, the sensor(s) 305 of FIG. 3 include image sensor(s) of camera(s) that capture image data 312. The image data 312 is illustrated in FIG. 3 as including an image of a man standing next to a van. In some examples, certain sets of sensors of the sensor(s) 305 of the AV 102 may be extrinsically calibrated before the AV 102 is permitted to drive in the environment. In some examples, the depth data processing system 300 can use the extrinsically calibration to map a location in the point data 310 to a location in the image data 312, and/or vice versa. In some examples, the depth data processing system 300 can use the extrinsically calibration to map location(s) in the point data 310 and/or in the image data 312 to real-world location(s) in the environment around the AV 102, and/or vice versa. In some examples, the depth data processing system 300 can fuse the point data 310 and the image data 312 together.

In some examples, the depth data processing system 300 can modify the point data 310 based on the image data 312. For example, the depth data processing system 300 can modify the point data 310 to align point(s) of the point data 310 based on object(s) detected as being depicted in the image data 312 using an object detection algorithm of the depth data processing system 300 and/or based on semantic segmentation of the points in the point data 310 using the semantic segmentation engine 315. In some examples, the depth data processing system 300 can modify the image data 312 based on the point data 310. For example, the depth data processing system 300 can modify the image data 312 to align portion(s) of the image data 312 to point(s) of the point data 310 based on object(s) detected as being depicted in the image data 312 using the object detection algorithm of the depth data processing system 300 and/or based on semantic segmentation of the points in the point data 310 using the semantic segmentation engine 315.

The depth data processing system 300 includes a semantic segmentation engine 315. The semantic segmentation engine 315 receives the point data 310 captured by the depth sensor(s) of the sensor(s) 305 as input(s). In some examples, the semantic segmentation engine 315 also receives other data captured by the sensor(s) 305, such as the image data 312 captured by the image sensor(s) of the sensor(s) 305, as input(s). In some examples, the semantic segmentation engine 315 receives a combination and/or fusion of the point data 310 and the image data 312 as input(s).

The semantic segmentation engine 315 identifies a type or class of object that each point in at least a subset of the point data 310 belongs to. For instance, for each point in the point data 310, the semantic segmentation engine 315 can identify whether the point represents a part of a pedestrian, a part of a bicyclist (e.g., person and/or bicycle), a part of a scooter, a part of a car, a part of a truck, a part of a motorcyclist (e.g., person and/or motorcycle), a part of a plant (e.g., a tree), a part of a structure (e.g., a building, a house, a lamp post), or a combination thereof. The semantic segmentation engine 315 may use, for instance, techniques such as feature extraction, feature detection, feature recognition, feature tracking, object detection, object recognition, object tracking, facial detection, facial recognition, facial tracking, body detection, body recognition, body tracking, vehicle detection, vehicle recognition, vehicle tracking, character detection, character recognition, character tracking, classification, or combinations thereof.

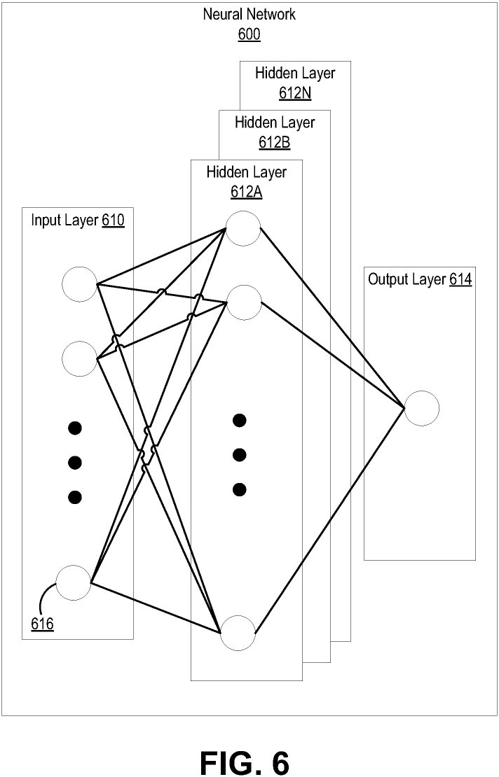

The semantic segmentation engine 315 includes and/or uses one or more trained machine learning (ML) models 317 of one or more ML systems to classify each point as corresponding to one of the particular types or classes of object. The trained ML model(s) 317 receive the point data 310 as input(s). In some examples, the trained ML model(s) 317 also receive the image data 312 and/or other sensor data from other sensor(s) 305 as input(s). In response to receiving these input(s), the trained ML model(s) 317 are trained to output a classification for each point in the point data 310. The ML system(s) may train the trained ML model(s) 317 using training data, for instance using supervised learning, unsupervised learning, deep learning, or combinations thereof. In some examples, the training data may include point data with pre-classified points. In some examples, the training data may include the image data 312 and/or other types of sensor data from the sensor(s) 305 corresponding to the point data with the pre-classified points. The trained ML model(s) 317, and/or the ML system(s) that train the trained ML model(s) 317, may include, for instance, one or more neural networks (NNs) (e.g., the NN 600 of FIG. 6), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more other types of neural networks, one or more trained support vector machines (SVMs), one or more trained random forests (RFs), or combinations thereof.

In some examples, the semantic segmentation engine 315 outputs categorized point data 320. The categorized point data 320 is similar to the point data 310, but includes category labels for at least a subset of the points of the point data 310. In some examples, each point in the categorized point data 320 includes a label identifying the type or class of object that the point belongs to. In some examples, a point in the categorized point data 320 can be labeled with multiple types or classes of object, for example if the point represents an intersection of two objects and could therefore be considered to belong to either or both of the two objects. The categorized point data 320 is illustrated in FIG. 3 as including the eight points of the point data 310, with certain points labeled as belonging to a car, a bike, or a pedestrian (“ped.”). In some examples, the semantic segmentation engine 315 outputs the category labels for the categorized point data 320. In some examples, the semantic segmentation engine 315 outputs a similarity matrix corresponding to classification of different points of the point data 310, such that the categorized point data 320 includes the similarity matrix.

The depth data processing system 300 includes a clustering engine 325. The clustering engine 325 receives the categorized point data 320 as input(s). In some examples, the clustering engine 325 also receives other sensor data captured by the sensor(s) 305, such as the image data 312, as input(s).

The clustering engine 325 clusters, or groups, points from the point data 310 that are near one another into clusters of points. The clustering engine 325 can cluster points in the point data 310 based on one or more distance measures and/or density measures. The clustering engine 325 can cluster the points in the categorized point data 320 using, for instance, density-based spatial clustering of applications with noise (DBSCAN) (e.g., clustering based on distance between nearest points), K-Means clustering (e.g., clustering based on distance between points), affinity propagation (e.g., clustering based on graph distance), mean-shift clustering (e.g., clustering based on distance between points), gaussian mixture clustering (e.g., clustering based on Mahalanobis distance to centers), spectral clustering (e.g., clustering based on graph distance), hierarchical agglomerative clustering (HAC) (e.g., clustering based on a hierarchy of clusters going from the bottom up and merging pairs of clusters as one moves up the hierarchy), hierarchical divisive clustering (HDC) (e.g., clustering based on a hierarchy of clusters going from the top down and splitting up clusters as one moves down the hierarchy), correlation clustering (e.g., clustering based on similarity and/or relationships between points), or a combination thereof.

In some examples, the clustering engine 325 cluster a set of points from the categorized point data 320 together into a cluster based on the points in the set being within a threshold distance of each other, of a centroid, of the nearest points of the set, another distance measure indicated in the list of clustering algorithms above, or a combination thereof. The distance measure may be measured as a Euclidean distance, a Manhattan distance, a Mahalanobis distance, a Minkowski distance, a Hamming distance, a graph distance, cosine distance, a Jaccard distance, or a combination thereof. In some examples, a similarity matrix may be used to affect how the threshold distance is calculated. The similarity matrix may be a representation of the semantic segmentation by the semantic segmentation engine 315. In some examples, the clustering engine 325 cluster a set of points from the categorized point data 320 together into a cluster based on the points in the set having at least a threshold point density. In some examples, the threshold distance and/or the threshold point density may be set based on the categorization of the points in the set of points to be clustered, as identified by the semantic segmentation engine 315.

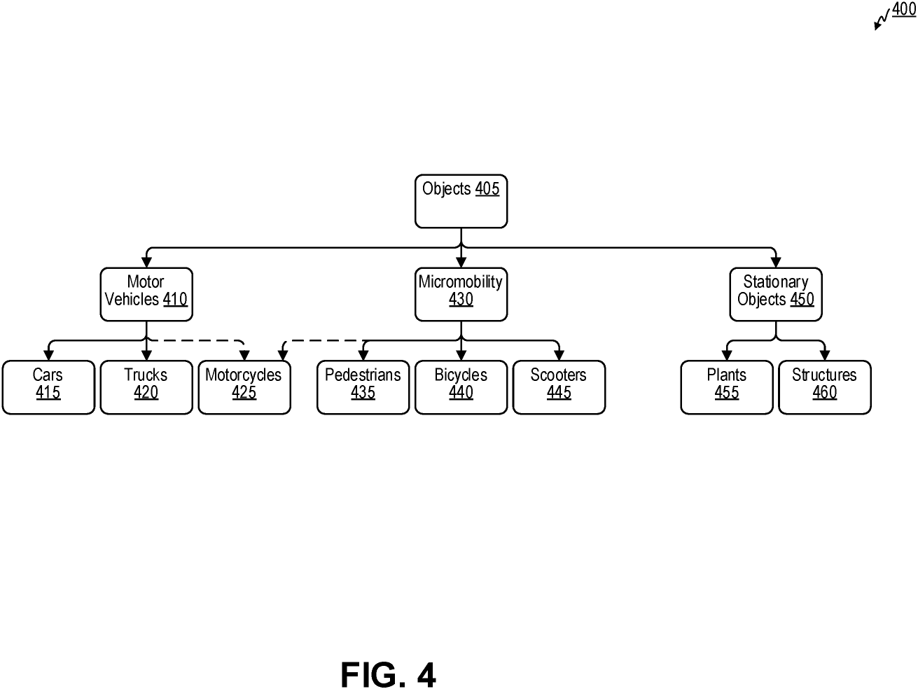

The clustering engine 325 receives not only the point data 310, but also the semantic segmentation by the semantic segmentation engine 315 (e.g., the categorizations of the points from the categorized point data 320) as input(s). The clustering engine 325 therefore clusters points from the point data 310 into clusters also based on which type or class of object the points belong to according to the categorized point data 320. In some examples, the semantic segmentation engine 315 classifies a first subset of the points into a first type or class of object, and classifies a second subset of the points into a second type or class of object. In some examples, the depth data processing system 300 configures the clustering engine 325 to ensure that points classified as belonging to different types or classes of objects (e.g., cars 415 and pedestrians 435) do not get clustered together into a single cluster. In some examples, the depth data processing system 300 configures the clustering engine 325 to ensure that points classified as belonging to certain types or classes of objects (e.g., bicycles 440 and pedestrians 435) can get clustered together into a single cluster. In some examples, the different types or classes of objects are arranged in a hierarchy with parent classes that each have one or more child classes, such as the hierarchy 400 of FIG. 4. In some examples, the depth data processing system 300 configures the clustering engine 325 to ensure that points classified as belonging to different parent classes in the hierarchy (e.g., motor vehicles 410, micromobility 430, or stationary objects 450) do not get clustered together not a single cluster.

The clustering engine 325 includes and/or uses one or more trained ML models 327 of one or more ML systems to cluster different subsets of the points in the categorized point data 320 into clusters, for instance based on distance between points and/or based on the semantic segmentation by the semantic segmentation engine 315. The trained ML model(s) 327 receive the categorized point data 320 as input(s). In some examples, the trained ML model(s) 327 also receive the image data 312 and/or other sensor data from other sensor(s) 305 as input(s). In response to receiving these input(s), the trained ML model(s) 327 are trained to output clustered point data 330 in which each point of at least a subset of the point data 310 is clustered into at least one of a set of clusters. The ML system(s) may train the trained ML model(s) 327 using training data, for instance using supervised learning, unsupervised learning, deep learning, or combinations thereof. In some examples, the training data may include point data that is pre-clustered into clusters. In some examples, the training data may include semantic segmentation by the semantic segmentation engine 315 (e.g., object type or class information for each point as in the categorized point data 320). In some examples, the training data may include the image data 312 and/or other types of sensor data from the sensor(s) 305 corresponding to the point data with the pre-classified points. The trained ML model(s) 327, and/or the ML system(s) that train the trained ML model(s) 327, may include, for instance, NN(s) (e.g., the NN 600 of FIG. 6), CNN(s), TDNN(s), deep network(s), autoencoder(s), DBN(s), RNN(s), GAN(s), other types of NN(s), trained SVM(s), trained RF(s), or combinations thereof.

In some examples, the clustering engine 325 outputs clustered point data 330. The clustered point data 330 clusters different sets of points in the point data 310 into clusters based on distance between points and/or based on the semantic segmentation by the semantic segmentation engine 315. The clustered point data 330 is illustrated in FIG. 3 as clustering the eight points of the categorized point data 320 into four clusters. The four clusters are indicated by circles within which clustered point fall inside. In some examples, the clustered point data 330 includes the semantic segmentation information from the categorized point data 320.

The depth data processing system 300 includes a boundary engine 335. The boundary engine 335 receives the clustered point data 330 and/or the categorized point data 320 as input(s). In some examples, the boundary engine 335 also receives other sensor data captured by the sensor(s) 305, such as the image data 312, as input(s).

The boundary engine 335 provides boundaries for objects corresponding to the clusters in the clustered point data 330 and/or the types or classes of object indicated in the categorized point data 320. The boundaries can include two-dimensional (2D) or three-dimensional (3D) bounding boxes, which can for instance be rectangles or rectangular prisms. The boundaries can include any polygonal shape, any polyhedral shape, any rounded shape, or a combination thereof. A shape and size of a boundary for a given object can be determined by the arrangement of points in the cluster corresponding to the object (in the clustered point data 330) and/or the type or class of object (in the categorized point data 320). For instance, a car can have a boundary that is relatively large and rectangular, or a rectangular prism, though in some cases can include some angled sides corresponding to certain portions of the car (e.g., side mirror(s), at least partially open door(s), at least partially open trunk, at least partially open hood, etc.). On the other hand, a pedestrian can have a boundary that is relatively small (e.g., smaller than that of a car) and can be rectangular, rectangular prism, or rounded to correspond to the rounder shape of a human being than a car.

The boundary engine 335 includes and/or uses one or more trained ML models 337 of one or more ML systems to generate boundaries for different objects in the environment represented by different clusters in the clustered point data 330 and/or points with different classifications in the categorized point data 320. The trained ML model(s) 337 receive the clustered point data 330 and/or the categorized point data 320 as input(s). In some examples, the trained ML model(s) 337 also receive the image data 312 and/or other sensor data from other sensor(s) 305 as input(s). In response to receiving these input(s), the trained ML model(s) 337 are trained to output bounded point data 340, which includes boundaries around subsets of the point data 310 based on corresponding clusters in the clustered point data 330 and/or classifications in the categorized point data 320. The ML system(s) may train the trained ML model(s) 337 using training data, for instance using supervised learning, unsupervised learning, deep learning, or combinations thereof. In some examples, the training data may include point data for which boundaries are pre-determined. In some examples, the training data may include corresponding clustering of the points (e.g., by the clustering engine 325) and/or corresponding semantic segmentation of the points (e.g., object type or class information for each point as in the categorized point data 320 as in by the semantic segmentation engine 315). In some examples, the training data may include the image data 312 and/or other types of sensor data from the sensor(s) 305 corresponding to the point data with the pre-classified points. The trained ML model(s) 337, and/or the ML system(s) that train the trained ML model(s) 337, may include, for instance, NN(s) (e.g., the NN 600 of FIG. 6), CNN(s), TDNN(s), deep network(s), autoencoder(s), DBN(s), RNN(s), GAN(s), other types of NN(s), trained SVM(s), trained RF(s), or combinations thereof.

In some examples, the boundary engine 335 outputs the bounded point data 340. The bounded point data 340 includes boundaries around subsets of the point data 310 based on corresponding clusters in the clustered point data 330 and/or classifications in the categorized point data 320. The bounded point data 340 is illustrated in FIG. 3 as including a large rectangular boundary for a car, a medium-sized rectangular boundary for a bicyclist, and two small rectangular boundaries for pedestrians. In some examples, the bounded point data 340 includes the cluster information from the clustered point data 330 and/or the semantic segmentation information from the categorized point data 320.

In some examples, the semantic segmentation engine 315, the clustering engine 325, and/or the boundary engine 335 can move and/or remove one or more points of the point data 310. In some examples, the semantic segmentation engine 315, the clustering engine 325, and/or the boundary engine 335 can move one or more points of the point data 310 toward a centroid of a cluster, toward a centroid of a boundary, toward a centroid of a set of points that received the same classification by the semantic segmentation engine 315, toward one or more other points of the cluster, toward one or more other points in the boundary, toward one or more other points that received the same classification by the semantic segmentation engine 315, or a combination thereof. some examples, the semantic segmentation engine 315, the clustering engine 325, and/or the boundary engine 335 can move one or more points of the point data 310 from a more sparse arrangement to a more dense arrangement. In some examples, the semantic segmentation engine 315, the clustering engine 325, and/or the boundary engine 335 can remove a point from a cluster and/or a boundary based on the classification of the point (e.g., in the categorized point data 320 as generated by the semantic segmentation engine 315) not matching the classification of the other points in the cluster and/or boundary, for instance by deleting the point entirely or moving the point so that the point is outside of the cluster radius of the cluster and/or outside of the boundary. In some examples, the semantic segmentation engine 315, the clustering engine 325, and/or the boundary engine 335 are trained to move and/or remove one or more points of the point data 310.

In some examples, depth data processing system 300 includes a mapping engine 345. The mapping engine 345 receives the bounded point data 340, the clustered point data 330, and/or the categorized point data 320 as input(s). In some examples, the mapping engine 345 also receives other sensor data captured by the sensor(s) 305, such as the image data 312, as input(s).

The mapping engine 345 combines the bounded point data 340, the clustered point data 330, and/or the categorized point data 320 with a map of the environment to identify positions and/or poses (e.g., location and/or orientation) of the objects bounded by the boundaries within the map of the environment. The map may include, for example, indications of streets or other thoroughfares, structures (e.g., buildings, houses), speed limit information, traffic information, satellite imagery, aircraft-photographed imagery, ground-vehicle-photographed imagery, elevation data, 3D model(s) of portions of the environment, depth data corresponding to portions of the environment, or a combination thereof.

The mapping engine 345 includes and/or uses one or more trained ML models 347 of one or more ML systems to identify the positions and/or poses of the objects bounded b the boundaries along the map of the environment. The trained ML model(s) 347 receive the bounded point data 340, the clustered point data 330, and/or the categorized point data 320 as input(s). In some examples, the trained ML model(s) 347 also receive the image data 312 and/or other sensor data from other sensor(s) 305 as input(s). In response to receiving these input(s), the trained ML model(s) 347 are trained to output map data 350, which includes the objects positioned on the map. The ML system(s) may train the trained ML model(s) 347 using training data, for instance using supervised learning, unsupervised learning, deep learning, or combinations thereof. In some examples, the training data may include point data that is pre-mapped. In some examples, the training data may include corresponding boundaries for objects that include the points (e.g., as in the bounded point data 340 by the boundary engine 335), corresponding clustering of the points (e.g., as in the clustered point data 330 by the clustering engine 325), and/or corresponding semantic segmentation of the points (e.g., object type or class information for each point as in the categorized point data 320 as in by the semantic segmentation engine 315). In some examples, the training data may include the image data 312 and/or other types of sensor data from the sensor(s) 305 corresponding to the point data with the pre-classified points. The trained ML model(s) 347, and/or the ML system(s) that train the trained ML model(s) 347, may include, for instance, NN(s) (e.g., the NN 600 of FIG. 6), CNN(s), TDNN(s), deep network(s), autoencoder(s), DBN(s), RNN(s), GAN(s), other types of NN(s), trained SVM(s), trained RF(s), or combinations thereof.

In some examples, the mapping engine 345 outputs the map data 350. The map data 350 includes, positioned on the map, the objects defined by the boundaries in the bounded point data 340, by the clusters in the clustered point data 330, and/or by the classifications in the categorized point data 320. The map data 350 is illustrated in FIG. 3 as including illustrations of a car, a bicyclist on a bicycle, and two pedestrians on a roadway. In some examples, the objects remain represented by the boundaries (e.g., as in the bounded point data 340) rather than the more realistic illustrations illustrated in the map data 350 of FIG. 3. In some examples, the map data 350 includes the boundary information from the bounded point data 340, the cluster information from the clustered point data 330, and/or the semantic segmentation information from the categorized point data 320.

In some examples, the semantic segmentation engine 315, the clustering engine 325, the boundary engine 335, and/or the mapping engine 345 can track the pose(s) (e.g., location(s) and/or orientation(s)) of the one or more objects through the environment (e.g., along the map of the environment from the map data 350) over time. The tracked objects may be defined by the boundaries, the clusters, and/or the semantic segmentations. For example, the semantic segmentation engine 315, the clustering engine 325, the boundary engine 335, and/or the mapping engine 345 can track movement of the car, the bicyclist on his bicycle, and the two pedestrians in the data (e.g., the point data 310, the categorized point data 320, the clustered point data 330, the bounded point data 340, and/or the map data 350) of FIG. 3. In some examples, the semantic segmentation engine 315, the clustering engine 325, the boundary engine 335, and/or the mapping engine 345 are trained to track the pose(s) (e.g., location(s) and/or orientation(s)) of the one or more objects through the environment (e.g., along the map of the environment from the map data 350) over time.

In some examples, the depth data processing system 300 includes a routing engine 355. The routing engine 355 receives the map data 350, the bounded point data 340, the clustered point data 330, and/or the categorized point data 320 as input(s). In some examples, the routing engine 355 also receives other sensor data captured by the sensor(s) 305, such as the image data 312, as input(s).

The routing engine 355 generates a route for an AV 102 through the environment based on the map data 350. The route for the AV 102 may be a route from a current pose (e.g., location and/or orientation) of the AV 102 within the environment to a target pose (e.g., location and/or orientation) of the AV 102 within the environment. The routing engine 355 generates a route for an AV 102 through the environment to avoid colliding with the objects (e.g., corresponding to the boundaries in the bounded point data 340, the clusters in the clustered point data 330, and/or the semantic segmentation in the categorized point data 320) and/or to follow the roadways on the map (e.g., from the map data 350). In some examples, the routing engine 355 predicts paths for the objects and generates the route not only to avoid a collision between the AV 102 and the current pose (e.g., location and/or orientation) of the objects, but also to avoid a collision between the AV 102 and one or more predicted future pose(s) (e.g., location(s) and/or orientation(s)) of the objects.

The routing engine 355 includes and/or uses one or more trained ML models 357 of one or more ML systems to generate the route. The trained ML model(s) 357 receive the map data 350, the bounded point data 340, the clustered point data 330, and/or the categorized point data 320 as input(s). In some examples, the trained ML model(s) 357 also receive the image data 312 and/or other sensor data from other sensor(s) 305 as input(s). In response to receiving these input(s), the trained ML model(s) 357 are trained to output route data 360, which identifies a route for the AV 102 through the environment. The ML system(s) may train the trained ML model(s) 357 using training data, for instance using supervised learning, unsupervised learning, deep learning, or combinations thereof. In some examples, the training data may include pre-defined optimal routes through maps with pose(s) (e.g., location(s) and/or orientation(s)) of objects located thereon. In some examples, the training data may include corresponding boundaries for the objects (e.g., as in the bounded point data 340 by the boundary engine 335), corresponding clustering of the points corresponding to the objects (e.g., as in the clustered point data 330 by the clustering engine 325), and/or corresponding semantic segmentation of the points corresponding to the objects (e.g., object type or class information for each point as in the categorized point data 320 as in by the semantic segmentation engine 315). In some examples, the training data may include the image data 312 and/or other types of sensor data from the sensor(s) 305 corresponding to the point data with the pre-classified points. The trained ML model(s) 357, and/or the ML system(s) that train the trained ML model(s) 357, may include, for instance, NN(s) (e.g., the NN 600 of FIG. 6), CNN(s), TDNN(s), deep network(s), autoencoder(s), DBN(s), RNN(s), GAN(s), other types of NN(s), trained SVM(s), trained RF(s), or combinations thereof.

In some examples, the routing engine 355 outputs the route data 360. The route data 360 identifies a route for the AV 102 through the environment that avoids potential collisions with identified objects and/or that ensures that the AV 102 follow the roadway and relevant laws and rules of the road. The route data 360 is illustrated in FIG. 3 as including a route for the AV 102 using a dotted arrow. The illustrated route stays on the roadway illustrated in the map data 350, and avoids the other car, the bicyclist on the bicycle, and the two pedestrians on the roadway. In some examples, the objects remain represented by the boundaries (e.g., as in the bounded point data 340) rather than the more realistic illustrations illustrated in the route data 360 of FIG. 3. In some examples, the route data 360 includes the map information from the map data 350, the boundary information from the bounded point data 340, the cluster information from the clustered point data 330, and/or the semantic segmentation information from the categorized point data 320.

In some examples, the depth data processing system 300 includes vehicle control system(s) 365. The vehicle control system(s) 365 include, for example, the vehicle propulsion system 130, the braking system 132, the safety system 136, the steering system 134, the cabin system 138, or a combination thereof. The depth data processing system 300 can use the vehicle control system(s) 365 to cause the AV 102 to autonomously drive the route defined in the route data 360 and generated by the routing engine 355.

In some examples, the depth data processing system 300 includes a feedback engine 370. The feedback engine 370 can detect feedback received from a user interface of the depth data processing system 300 and/or of the AV 102. The feedback engine 370 can receive, detect, and/or generate feedback about one or more of the engines of the depth data processing system 300, such as the semantic segmentation engine 315, the clustering engine 325, the boundary engine 335, the mapping engine 345, and/or the routing engine 355. The feedback engine 370 can receive, detect, and/or generate feedback about data that is at least partially generated by one or more of the engines of the depth data processing system 300, for instance including the point data 310, the semantic segmentation in the categorized point data 320, the clustering in the clustered point data 330, the boundaries in the bounded point data 340, the map data 350, the route of the route data 360, the tracking of movement of obj ects, the movement of points in the point data 310, the removal of points from the point data 310, or a combination thereof. The feedback engine 370 can detect feedback about one the engines of the of the depth data processing system 300 received from another one the engines of the of the depth data processing system 300, for instance whether one engine decides to use data from the other engine or not.

The feedback received, detected, and/or generated by the feedback engine 370 can be positive feedback or negative feedback. For instance, if the one engine of the depth data processing system 300 uses data from another engine of the depth data processing system 300, the feedback engine 370 can interpret this as positive feedback. If the one engine of the depth data processing system 300 declines to use data from another engine of the depth data processing system 300 (e.g., due to detected inaccuracies or messy data), the feedback engine 370 can interpret this as negative feedback. Positive feedback can also be based on attributes of the sensor data from the sensor(s) 305, such as a user smiling, laughing, nodding, saying a positive statement (e.g., “yes,” “confirmed,” “okay,” “next”), or otherwise positively reacting to the data generated by the engine(s) and/or the AV 102′s actions based on that data. Negative feedback can also be based on attributes of the sensor data from the sensor(s) 305, such as the user frowning, crying, shaking their head (e.g., in a “no” motion), saying a negative statement (e.g., “no,” “negative,” “bad,” “not this”), or otherwise negatively reacting to the data generated by the engine(s) and/or the AV 102′s actions based on that data.

In some examples, the feedback engine 370 provides the feedback to one or more ML systems of the depth data processing system 300 as training data to update the one or more ML systems of the depth data processing system 300. For instance, the feedback engine 370 can provide the feedback as training data to the ML system(s) associated with the trained ML model(s) 317 of the semantic segmentation engine 315, the trained ML model(s) 327 of the clustering engine 325, the trained ML model(s) 337 of the boundary engine 335, the trained ML model(s) 347 of the mapping engine 345, and/or the trained ML model(s) 357 of the routing engine 355. Positive feedback can be used to strengthen and/or reinforce weights associated with the outputs of the ML system(s) and/or the trained ML model(s). Negative feedback can be used to weaken and/or remove weights associated with the outputs of the ML system(s) and/or the trained ML model(s).

In some examples, any of the engines of the depth data processing system 300 (e.g., the semantic segmentation engine 315, the clustering engine 325, the boundary engine 335, the mapping engine 345, the routing engine 355, and/or the feedback engine 370) can include a software element, such as a set of instructions corresponding to a program, that is run on a processor such as the processor 810 of the computing system 800. In some examples, engines of the depth data processing system 300 include one or more hardware elements. For instance, the engines of the depth data processing system 300 can include a processor such as the processor 810 of the computing system 800. In some examples, the engines of the depth data processing system 300 include a combination of one or more software elements and one or more hardware elements.

FIG. 4 is a conceptual diagram illustrating hierarchy 400 of object categories for the semantic segmentation engine. The hierarchy 400 includes categories of objects 405, including three parent classes or categories and eight child classes or categories. The first parent class or category is motor vehicles 410, which includes the three child classes or categories of cars 415, trucks 420, and motorcycles 425. The second parent class or category is micromobility 430, which includes the three child classes or categories of pedestrians 435, bicycles 440, and scooters 445. In some examples, the child class or category of motorcycles 425 can belong to the micromobility 430 parent class or category instead of, or in addition to, the motor vehicles 410 parent class or category. The third parent class or category is stationary objects 450, which includes the two child classes or categories of plants 455 (e.g., trees, bushes, grass, flowers, etc.) and structures 460 (e.g., buildings, houses, lamp posts, etc.).

In some examples, the depth data processing system 300 configures the clustering engine 325 to ensure that points classified as belonging to different types or classes of objects in the hierarchy 400 (e.g., cars 415, pedestrians 435, bicycles 440) do not get clustered together into a single cluster. In some examples, the depth data processing system 300 configures the clustering engine 325 to ensure that points classified as belonging to different parent classes in the hierarchy (e.g., motor vehicles 410, micromobility 430, or stationary objects 450) do not get clustered together not a single cluster.

In some examples, other objects may be included in the hierarchy 400 beyond the listed objects. For example, the micromobility 430 parent class or category may also include skateboarders, rollerbladers, and the like. The motor vehicles 410 parent class or category may also include boats, airplanes, and other motorized vehicles. In some examples, parked vehicles may be categorized under the stationary objects 450 parent category or class. In some examples, parked vehicles may be categorized under the motor vehicles 410 or micromobility 430 parent category or class, depending on the type of vehicle - because it is safest if the AV 102 treats any parked vehicle as if the parked vehicle may start moving again at any time, since parked vehicles sometimes begin moving at unexpected times.

As used herein, the terms object class, object type, type of object, categorization, classification, and semantic segmentation can be used to refer to categorization or classification of points in point data, for instance into one of the classes, types, or categories in the hierarchy 400.

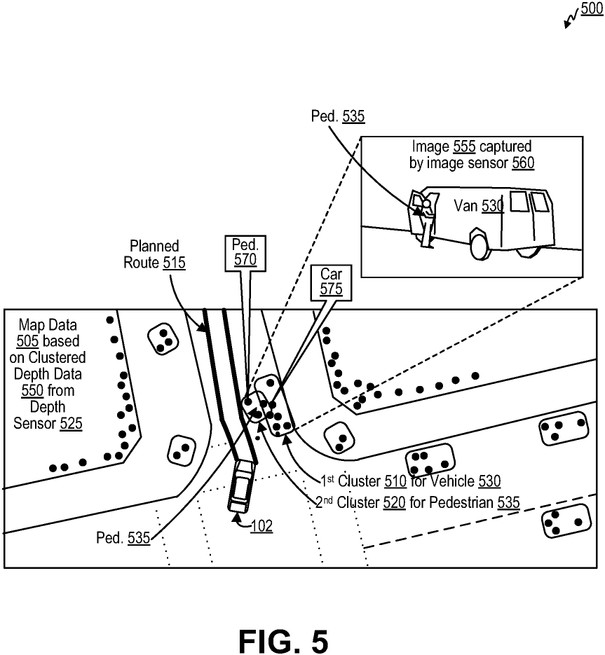

FIG. 5 is a conceptual diagram illustrating map data 505 for of an environment based on clustered depth data 550 that is clustered based on semantic segmentation. The clustered depth data 550 includes depth data from a depth sensor 525 of the AV 102, which may be an example of the sensor(s) 305. The clustered depth data 550 may be an example of the clustered point data 330, and is based on categorized depth data similar to the categorized point data 320. Various points are illustrated overlaid over a map, with clusters and/or boundaries identified as rounded rectangular outlines around sets of points. Two large buildings are identified as structures 460 based on the large numbers of points. Various cars and pedestrians are identified, including a van 530 and a pedestrian 535 that are also depicted in an image 555 captured by an image sensor 560 of the AV 102. The points in the map data 505 corresponding to the van 530 are clustered in the first cluster 510 and include a car label 575 from the semantic segmentation (e.g., using the semantic segmentation engine 315). The points in the map data 505 corresponding to the pedestrian 535 are clustered in the second cluster 520 and include a pedestrian label 570 from the semantic segmentation (e.g., using the semantic segmentation engine 315). A planned route 515 (e.g., part of the route data 360 generated by the routing engine 355) is illustrated, and avoids both the pedestrian 535 and the van 530.

FIG. 6 is a block diagram illustrating an example of a neural network (NN) 600 that can be used is for environment analysis. The neural network 600 can include any type of deep network, such as a convolutional neural network (CNN), an autoencoder, a deep belief net (DBN), a Recurrent Neural Network (RNN), a Generative Adversarial Networks (GAN), and/or other type of neural network. In some examples, the NN 600 may be an example of the trained ML model(s) 317 of the semantic segmentation engine 315, the trained ML model(s) 327 of the clustering engine 325, the trained ML model(s) 337 of the boundary engine 335, the trained ML model(s) 347 of the mapping engine 345, and/or the trained ML model(s) 357 of the routing engine 355, ML system(s) that train any of the previously-listed trained ML model(s), or a combination thereof.

An input layer 610 of the neural network 600 includes input data. The input data of the input layer 610 can include sensor data (or features thereof) captured by one or more sensor(s) of the AV 102, such as the sensor system 1 104, the sensor system 2 106, the sensor system 3 108, the sensor(s) 305, the depth sensor 525, the image sensor 560, the one or more depth sensors of operation 705, any other sensors described herein, or a combination thereof. In some examples, the input data of the input layer 610 includes metadata associated with the sensor data. The input data of the input layer 610 can include data representing the point data 310, the semantic segmentation in the categorized point data 320, the clustering in the clustered point data 330, the boundaries in the bounded point data 340, the map data 350, the route of the route data 360, the tracking of movement of objects, the movement of points in the point data 310, the removal of points from the point data 310, or a combination thereof. In some examples, the input data of the input layer 610 includes information about the AV 102, such as the pose of the AV 102, the speed of the AV 102, the velocity of the AV 102, the direction of the AV 102, the acceleration of the AV 102, or a combination thereof. The pose of the AV 102 can include the location (e.g., latitude, longitude, altitude/elevation) and/or orientation (e.g., pitch, roll, yaw) of the vehicle 205.

The neural network 600 includes multiple hidden layers 612A, 612B, through 612N. The hidden layers 612A, 612B, through 612N include “N” number of hidden layers, where “N” is an integer greater than or equal to one. The number of hidden layers can be made to include as many layers as needed for the given application. The neural network 600 further includes an output layer 614 that provides an output resulting from the processing performed by the hidden layers 612A, 612B, through 612N.

In some examples, the output layer 614 can provide semantic segmentation of points of depth data (e.g., as in the categorized point data 320), clustering of sets of points of depth data (e.g., as in the clustered point data 330), boundaries for sets of points of depth data (e.g., as in the bounded point data 340), an arrangement of object(s) and/or boundarie(s) and/or cluster(s) on a map (e.g., as in the map data 350), a route through an environment that avoids object(s) and/or boundarie(s) and/or cluster(s) (e.g., as in the route data 360), tracking of movement of object(s), movement of point(s) in point data, removal of points from point data, or a combination thereof.

The neural network 600 is a multi-layer neural network of interconnected filters. Each filter can be trained to learn a feature representative of the input data. Information associated with the filters is shared among the different layers and each layer includes information as information is processed. In some cases, the neural network 600 can include a feed-forward network, in which case there are no feedback connections where outputs of the network are fed back into itself. In some cases, the network 600 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 610 can activate a set of nodes in the first hidden layer 612A. For example, as shown, each of the input nodes of the input layer 610 can be connected to each of the nodes of the first hidden layer 612A. The nodes of a hidden layer can transform the information of each input node by applying activation functions (e.g., filters) to this information. The information derived from the transformation can then be passed to and can activate the nodes of the next hidden layer 612B, which can perform their own designated functions. Example functions include convolutional functions, downscaling, upscaling, data transformation, and/or any other suitable functions. The output of the hidden layer 612B can then activate nodes of the next hidden layer, and so on. The output of the last hidden layer 612N can activate one or more nodes of the output layer 614, which provides a processed output image. In some cases, while nodes (e.g., node 616) in the neural network 600 are shown as having multiple output lines, a node has a single output and all lines shown as being output from a node represent the same output value.

In some cases, each node or interconnection between nodes can have a weight that is a set of parameters derived from the training of the neural network 600. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 610 using the different hidden layers 612A, 612B, through 612N in order to provide the output through the output layer 614.

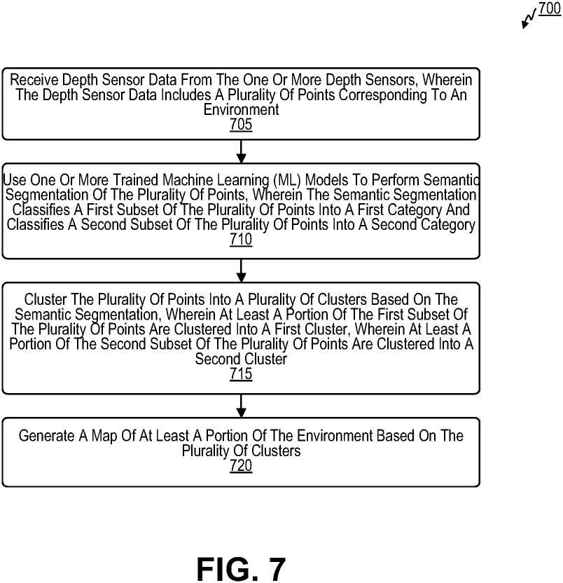

FIG. 7 is a flow diagram illustrating a process 700 for environmental analysis. The process 700 for environmental analysis is performed by an analysis system. The analysis system includes, for instance, the AV 102, the local computing device 110, the sensor systems 104-108, the client computing device 170, the data center 150, the data management platform 152, the AI/ML platform 154, the simulation platform 156, the remote assistant platform 158, the ridesharing platform 160, the depth data processing system 300, the sensor(s) 305, the semantic segmentation engine 315, the clustering engine 325, the boundary engine 335, the mapping engine 345, the routing engine 355, and/or the feedback engine 370, the neural network 600, the computing system 800, the processor 810, or a combination thereof.

At operation 705, the analysis system is configured to, and can, receive depth sensor data from the one or more depth sensors, wherein the depth sensor data includes a plurality of points corresponding to an environment. Examples of the one or more depth sensors include RADAR sensors, LIDAR sensors, pseudo-LIDAR sensors, SONAR sensors, SODAR sensors, ultrasonic sensors, ToF sensors, structured light sensors, or combinations thereof. Examples of the one or more depth sensors include the sensor system 1 104, the sensor system 2 106, the sensor system 3 108, the sensor(s) 305, the depth sensor 525, the input device(s) 845, any other sensors or sensors systems described herein, or a combination thereof. Examples of the depth sensor data include the point data in FIG. 2, the point data 310, and the point data in FIG. 5, one or more point clouds, one or more depth images, one or more depth videos, one or more range images, one or more range videos, one or more 3D models, one or more distance measurements, or a combination thereof.

In some examples, the analysis system is configured to, and can, receive, other types of sensor data from other sensor(s), such as sensor data from image sensor(s) of camera(s), microphone(s), pose sensor(s), inertial measurement unit(s), gyroscope(s), gyrometer(s), accelerometer(s), altimeter(s), barometer(s), more positioning receiver(s), such as GNSS receiver(s), GPS receiver(s), accelerometer(s), altimeter(s), barometer(s), Wi-Fi transceivers, cellular network transceivers, wireless local area network (WLAN) transceivers, Bluetooth transceivers, beacon transceivers, personal area network (PAN) transceivers, municipal area network (MAN) transceivers, wide area network (WAN) transceivers, communication interface(s) 840, engine sensor(s), speedometer(s), tachometer(s), odometer(s), altimeter(s), tilt sensor(s), impact sensor(s), airbag sensor(s), seat occupancy sensor(s), open/closed door sensor(s), on/off light sensor(s), tire pressure sensor(s), rain sensor(s), or combinations thereof. In some examples, the sensor data can include image data (e.g., the image data 312) from image sensor(s) of the sensor(s) 305 and/or image data (e.g., the image 555) from the image sensor 560.

In some examples, the analysis system includes at least one sensor connector that couples the analysis system (and/or one or more processors thereof) to the one or more depth sensors and/or other sensors. In some examples, the analysis system receives the depth data from the one or more depth sensors (and/or other sensor data from the one or more other sensors) using the sensor connector. In some examples, the analysis system receives the depth data from the sensor connector when the analysis system receives the depth data from the one or more depth sensors. In some examples, the depth sensors are coupled to a housing of the analysis system. The housing may be a housing of a vehicle, such as a housing of the AV 102.

At operation 710, the analysis system is configured to, and can, use one or more trained machine learning (ML) models to perform semantic segmentation of the plurality of points. The semantic segmentation classifies a first subset of the plurality of points into a first category and classifies a second subset of the plurality of points into a second category. Examples of the one or more trained ML models include one or more trained ML models of the AI/ML platform 154, the trained ML model(s) 317 of the semantic segmentation engine 315, the trained MLmodel(s) 327 of the clustering engine 325, the trained ML model(s) 337 of the boundary engine 335, the trained MLmodel(s) 347 of the mapping engine 345, and/or the trained MLmodel(s) 357 of the routing engine 355, ML system(s) that train any of the previously-listed trained ML model(s), the NN 600, or a combination thereof. Examples of the semantic segmentation include semantic segmentation by the semantic segmentation engine 315 and/or the trained ML model(s) 317. Examples of the semantic segmentation include the categorized point data 320. Examples of the semantic segmentation include the pedestrian label 570 and the car label 575. In some examples, the first category and the second category are found in the hierarchy 400, or a similar hierarchy.

In some examples, the first subset of the plurality of points and the second subset of the plurality of points do not share any of the plurality of points in common. For instance, in some examples, each of the points can only be in one category at a time. In some examples, the first subset of the plurality of points and the second subset of the plurality of points share at least one of the plurality of points in common. For instance, in some examples, a point can only be in more than one category at a time.

In some examples, the first category is associated with one or more pedestrians 435, wherein the second category is associated with one or more vehicles (e.g., motor vehicles 410, cars 415, trucks 420, motorcycles 425, bicycles 440, scooters 445).

In some examples, the first category and the second category are both part of a hierarchy of categories, such as the hierarchy 400. In some aspects, the first category is a first child category of a first parent category in the hierarchy of categories and the second category is a second child category of a second parent category (distinct from the first parent category) in the hierarchy of categories. For instance, the first category can be a child category of the micromobility 430 parent category, while the second category can be a child category of the motor vehicles 410 parent category. In some aspects, the first category is a first child category of a parent category in the hierarchy of categories, and the second category is a second child category of the same parent category in the hierarchy of categories. For example, the first category and the second category can both be child categories of the micromobility 430 parent category, or of the motor vehicles 410 parent category, or of the stationary objects 450 parent category.

At operation 715, the analysis system is configured to, and can, cluster the plurality of points into a plurality of clusters based on the semantic segmentation. At least a portion of the first subset of the plurality of points are clustered into a first cluster. At least a portion of the second subset of the plurality of points are clustered into a second cluster. Examples of the clustering of the plurality of points into the plurality of clusters based on the semantic segmentation includes the generation (e.g., the clustering) of the clustered point data 330 based on the semantic segmentation of the categorized point data 320, the generation (e.g., the clustering) of the first cluster 510 based on the car label 575 for the points corresponding to the van 530, the generation (e.g., the clustering) of the second cluster 520 based on the pedestrian label 570 for the points corresponding to the pedestrian 535, or a combination thereof.

In some examples, the analysis system is configured to, and can, use one or more trained ML models to cluster the plurality of points into the plurality of clusters based on the semantic segmentation. Examples of the one or more trained ML models include one or more trained ML models of the AI/ML platform 154, the trained ML model(s) 317 of the semantic segmentation engine 315, the trained MLmodel(s) 327 of the clustering engine 325, the trained ML model(s) 337 of the boundary engine 335, the trained ML model(s) 347 of the mapping engine 345, and/or the trained ML model(s) 357 of the routing engine 355, ML system(s) that train any of the previously-listed trained MLmodel(s), the NN 600, or a combination thereof.

In some examples, the first cluster corresponds to the first category and the second cluster corresponds to the second category.

In some examples, the first cluster includes at least the portion of the first subset of the plurality of points and at least one additional point missing from the first subset of the plurality of points. For instance, the first category may be a child category, and the first cluster can include another point in another child class under the same parent class as the first category. In some examples, the second cluster includes at least the portion of the second subset of the plurality of points and at least one additional point missing from the second subset of the plurality of points. For instance, the second category may be a child category, and the second cluster can include another point in another child category under the same parent category as the second category.

In some examples, clustering the plurality of points into a plurality of clusters based on the semantic segmentation includes clustering the plurality of points into a plurality of clusters based on a threshold distance that is based on the semantic segmentation. Examples of the threshold distance based on the semantic segmentation include the cluster radius 210 for motor vehicles 215 and the cluster radius 220 for pedestrians 225. In some aspects, at least the portion of the first subset of the plurality of points are clustered into the first cluster based on at least the portion of the first subset of the plurality of points being offset from one another by less than the threshold distance. In some aspects, at least the portion of the first subset of the plurality of points are clustered into the first cluster and at least the portion of the second subset of the plurality of points are clustered into the second cluster based on at least the portion of the first subset of the plurality of points being offset from at least the portion of the second subset of the plurality of points by at least the threshold distance.

In some examples, clustering the plurality of points into a plurality of clusters based on the semantic segmentation includes clustering the plurality of points into a plurality of clusters based on a first threshold distance associated with the first category and a second threshold distance associated with the second category. Examples of the first threshold distance associated with the first category and the second threshold distance associated with the second category include the cluster radius 210 for motor vehicles 215 and the cluster radius 220 for pedestrians 225. In some aspects, at least the portion of the first subset of the plurality of points are clustered into the first cluster based on at least the portion of the first subset of the plurality of points being offset from one another by less than the first threshold distance, and at least the portion of the second subset of the plurality of points are clustered into the second cluster based on at least the portion of the second subset of the plurality of points being offset from one another by less than the second threshold distance. In some aspects, at least the portion of the first subset of the plurality of points are clustered into the first cluster and at least the portion of the second subset of the plurality of points are clustered into the second cluster based on at least the portion of the first subset of the plurality of points being offset from at least the portion of the second subset of the plurality of points by at least one of the first threshold distance and the second threshold distance.

In some examples, the threshold distance, the first threshold distance, and/or the second threshold distance are at least one of a Euclidean distance, a Manhattan distance, a Mahalanobis distance, a Minkowski distance, a Hamming distance, a graph distance, cosine distance, a Jaccard distance, or a combination thereof.

In some examples, clustering the plurality of points into a plurality of clusters based on the semantic segmentation includes clustering the plurality of points into a plurality of clusters based on a threshold density that is based on the semantic segmentation.

In some examples, clustering the plurality of points into a plurality of clusters is based on density-based spatial clustering of applications with noise (DBSCAN) (e.g., clustering based on distance between nearest points), K-Means clustering (e.g., clustering based on distance between points), affinity propagation (e.g., clustering based on graph distance), mean-shift clustering (e.g., clustering based on distance between points), gaussian mixture clustering (e.g., clustering based on Mahalanobis distance to centers), spectral clustering (e.g., clustering based on graph distance), hierarchical agglomerative clustering (HAC) (e.g., clustering based on a hierarchy of clusters going from the bottom up and merging pairs of clusters as one moves up the hierarchy), hierarchical divisive clustering (HDC) (e.g., clustering based on a hierarchy of clusters going from the top down and splitting up clusters as one moves down the hierarchy), correlation clustering (e.g., clustering based on similarity and/or relationships between points), or a combination thereof.

At operation 720, the analysis system is configured to, and can, generate a map of at least a portion of the environment based on the plurality of clusters. Examples of the map include the bounded point data 340, the map data 350, the route data 360, and/or the map data 505. In some examples, the analysis system generate a map of at least a portion of the environment based also on the semantic segmentation and/or one or more boundaries (e.g., the boundaries determined based on the clusters and/or the semantic segmentation). Examples of generation of the map includes generation of the bounded point data 340 by the boundary engine 335, generation of the map data 350 by the mapping engine 345, generation of the route data 360 by the routing engine 355, or a combination thereof.

In some examples, the analysis system is configured to, and can, use one or more trained ML models to generate the map of at least the portion of the environment based on the plurality of clusters and/or the semantic segmentation and/or the boundaries. Examples of the one or more trained ML models include one or more trained ML models of the AI/ML platform 154, the trained ML model(s) 317 of the semantic segmentation engine 315, the trained ML model(s) 327 of the clustering engine 325, the trained ML model(s) 337 of the boundary engine 335, the trained ML model(s) 347 of the mapping engine 345, and/or the trained ML model(s) 357 of the routing engine 355, MLsystem(s) that train any of the previously-listed trained MLmodel(s), the NN 600, or a combination thereof.

In some examples, the housing is at least part of a vehicle, such as the AV 102. The analysis system is configured to, and can, generate a route for the vehicle based on the map. Examples of the route include the route from the route data 360 generated by the routing engine 355. Examples of generation of the route include generation of the route from the route data 360 by the routing engine 355. The analysis system is configured to, and can, cause the vehicle to autonomously traverse the route, for instance using the vehicle control system(s) 365.

In some examples, the analysis system is configured to, and can, use one or more trained ML models to generate the route. Examples of the one or more trained ML models include one or more trained ML models of the AI/ML platform 154, the trained ML model(s) 317 of the semantic segmentation engine 315, the trained ML model(s) 327 of the clustering engine 325, the trained ML model(s) 337 of the boundary engine 335, the trained ML model(s) 347 of the mapping engine 345, and/or the trained ML model(s) 357 of the routing engine 355, ML system(s) that train any of the previously-listed trained ML model(s), the NN 600, or a combination thereof

In some examples, the analysis system is configured to, and can, generate a first boundary for the first cluster and/or the first subset of points and/or the first category. In some examples, the analysis system is configured to, and can, generate a second boundary for the second cluster and/or the second subset of points and/or the second category. The first boundary and/or the second boundary may be boundarie(s) of object(s). The first boundary and/or the second boundary may be the clusters and/or the semantic segmentation, as in the boundaries of the bounded point data 340 generated by the boundary engine 335. In some aspects, a shape of the first boundary and/or the second boundary includes a two-dimensional (2D) polygon, such as a rectangle, a triangle, a square, a trapezoid, a parallelogram, a quadrilateral, a pentagon, a hexagon, another polygon, a portion thereof, or a combination thereof. In some examples, the shape of the first boundary and/or the second boundary includes a round two-dimensional (2D) shape, such as a circle, a semicircle, an ellipse, another rounded 2D shape, a portion thereof, or a combination thereof. In some examples, a shape of the first boundary and/or the second boundary includes a three-dimensional (3D) polyhedron. For example, the shape of the boundary can include a rectangular prism, a cube, a pyramid, a triangular prism, a prism of a another polygon, a tetrahedron, another polyhedron, a portion thereof, or a combination thereof. In some examples, the boundary for the vehicle can include a round three-dimensional (3D) shape, such as a sphere, an ellipsoid, a cone, a cylinder, another rounded 3D shape, a portion thereof, or a combination thereof. In some examples, the analysis system is configured to, and can, generate the map based on the first boundary and/or the second boundary. In some examples, the analysis system is configured to, and can, generate the route based on the first boundary and/or the second boundary, for instance to avoid the first boundary and/or the second boundary.

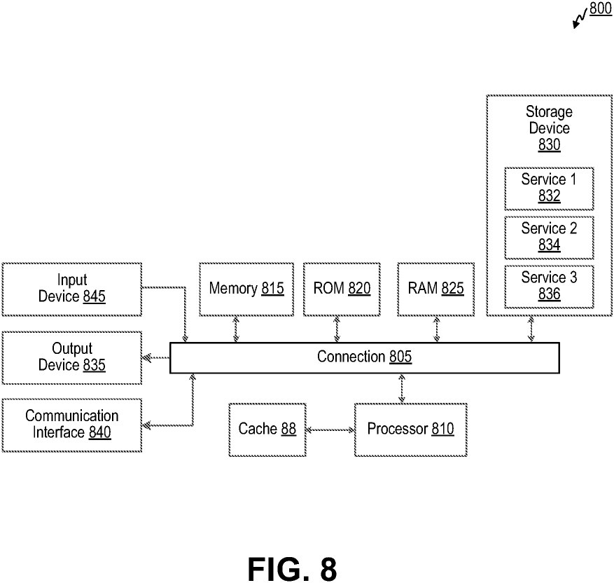

FIG. 8 shows an example of computing system 800, which can be for example any computing device making up the AV 102, the local computing device 110, the sensor systems 104-108, the client computing device 170, the data center 150, the data management platform 152, the AI/ML platform 154, the simulation platform 156, the remote assistant platform 158, the ridesharing platform 160, the depth data processing system 300, the sensor(s) 305, the semantic segmentation engine 315, the clustering engine 325, the boundary engine 335, the mapping engine 345, the routing engine 355, and/or the feedback engine 370, the neural network 600, the computing system 800, the processor 810, any combination thereof, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including system memory 815, such as read-only memory (ROM) 820 and random access memory (RAM) 825 to processor 810. Computing system 800 can include a cache of high-speed memory 812 connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 602.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

What is claimed is:

1. A system for depth data processing, the system comprising:
a sensor connector configured to couple one or more processors to one or more depth sensors that are coupled to a housing;
one or more memory units storing instructions; and
the one or more processors within the housing, wherein execution of the instructions by the one or more processors causes the one or more processors to:
receive depth sensor data from the one or more depth sensors, wherein the depth sensor data includes a plurality of points corresponding to an environment;
use one or more trained machine learning (ML) models to perform semantic segmentation of the plurality of points, wherein the semantic segmentation classifies a first subset of the plurality of points into a first category and classifies a second subset of the plurality of points into a second category;
cluster the plurality of points into a plurality of clusters based on the semantic segmentation, wherein at least a portion of the first subset of the plurality of points are clustered into a first cluster, wherein at least a portion of the second subset of the plurality of points are clustered into a second cluster; and
generate a map of at least a portion of the environment based on the plurality of clusters.

2. The system of claim 1, wherein the first cluster includes at least the portion of the first subset of the plurality of points and at least one additional point missing from the first subset of the plurality of points.

3. The system of claim 1, wherein the first subset of the plurality of points and the second subset of the plurality of points do not share any of the plurality of points in common.

4. The system of claim 1, wherein the first cluster corresponds to the first category and the second cluster corresponds to the second category.

5. The system of claim 1, wherein the housing is at least part of a vehicle, wherein execution of the instructions by the one or more processors causes the one or more processors to:
generate a route for the vehicle based on the map.

6. The system of claim 5, wherein execution of the instructions by the one or more processors causes the one or more processors to:
cause the vehicle to autonomously traverse the route.

7. The system of claim 1, wherein the first category is associated with one or more pedestrians, wherein the second category is associated with one or more vehicles.

8. The system of claim 1, wherein the first category and the second category are both part of a hierarchy of categories.

9. The system of claim 8, wherein the first category is a first child category of a first parent category in the hierarchy of categories, wherein the second category is a second child category of a second parent category in the hierarchy of categories, wherein the first parent category is distinct from the second parent category.

10. The system of claim 8, wherein the first category is a first child category of a parent category in the hierarchy of categories, wherein the second category is a second child category of the parent category in the hierarchy of categories.

11. The system of claim 1, wherein clustering the plurality of points into a plurality of clusters based on the semantic segmentation includes clustering the plurality of points into a plurality of clusters based on a threshold distance that is based on the semantic segmentation.

12. The system of claim 11, wherein at least the portion of the first subset of the plurality of points are clustered into the first cluster based on at least the portion of the first subset of the plurality of points being offset from one another by less than the threshold distance.

13. The system of claim 11, wherein at least the portion of the first subset of the plurality of points are clustered into the first cluster and at least the portion of the second subset of the plurality of points are clustered into the second cluster based on at least the portion of the first subset of the plurality of points being offset from at least the portion of the second subset of the plurality of points by at least the threshold distance.

14. The system of claim 1, wherein clustering the plurality of points into a plurality of clusters based on the semantic segmentation includes clustering the plurality of points into a plurality of clusters based on a first threshold distance associated with the first category and a second threshold distance associated with the second category.

15. The system of claim 14, wherein at least the portion of the first subset of the plurality of points are clustered into the first cluster based on at least the portion of the first subset of the plurality of points being offset from one another by less than the first threshold distance, wherein at least the portion of the second subset of the plurality of points are clustered into the second cluster based on at least the portion of the second subset of the plurality of points being offset from one another by less than the second threshold distance.

16. The system of claim 14, wherein at least the portion of the first subset of the plurality of points are clustered into the first cluster and at least the portion of the second subset of the plurality of points are clustered into the second cluster based on at least the portion of the first subset of the plurality of points being offset from at least the portion of the second subset of the plurality of points by at least one of the first threshold distance and the second threshold distance.

17. The system of claim 1, wherein the one or more depth sensors include a radio detection and ranging (RADAR) sensor.

18. The system of claim 1, wherein the one or more depth sensors include a light detection and ranging (LIDAR) sensor.

19. The system of claim 1, wherein clustering the plurality of points into a plurality of clusters is based on density-based spatial clustering of applications with noise (DBSCAN).

20. A method for depth data processing, the method comprising:
receiving depth sensor data from one or more depth sensors, wherein the depth sensor data includes a plurality of points corresponding to an environment;
using one or more trained machine learning (ML) models to perform semantic segmentation of the plurality of points, wherein the semantic segmentation classifies a first subset of the plurality of points into a first category and classifies a second subset of the plurality of points into a second category;
cluster the plurality of points into a plurality of clusters based on the semantic segmentation, wherein at least a portion of the first subset of the plurality of points are clustered into a first cluster, wherein at least a portion of the second subset of the plurality of points are clustered into a second cluster; and
generating a map of at least a portion of the environment based on the plurality of clusters.
